(19) United States
(12) Patent Application Publication
(10) Pub. No.: US 2009/0194348 A1
(43) Pub. Date: Aug. 6, 2009

(54) AUTOMOTIVE HOOD-HINGE SYSTEM

(76) Inventors: Robert J. Faubert, Shelby Twp., MI (US); Richard A. Manning, Sterling Heights, MI (US); Raja Hazime, Dearborn Heights, MI (US); Kenneth E. Spieles, Shelby Twp., MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 12/023,290

(22) Filed: Jan. 31, 2008

(51) Int. Cl. B62D 25/12; E05D 7/00; B60J 7/00

(52) U.S. Cl. 180/69.21; 16/221; 296/193.11

(57) ABSTRACT

A hood-hinge assembly may include at least one structural member, a hinge linkage moveable between a closed position and an open position, and a hinge bracket disposed on the at least one structural member and supporting the hinge linkage. The hinge bracket being deformable in response to a force applied to the hinge linkage.

### FIELD

The present disclosure relates to a hinge system and in particular to a hood-hinge system for a vehicle.

### BACKGROUND

The statements in this section merely provide background information related to the present disclosure and may not constitute prior art.

Vehicle hoods typically include a hinge mechanism for pivotably opening and/or closing the hood. Such hinge mechanisms typically allow the hood to freely pivot from an open position to a closed position under the force of the hood's weight. A prop rod may also be provided to pivotably engage a frame of an engine compartment to hold the hood in the open position and provide access to the engine component. While the prop rod adequately holds the hood in the open position, the prop rod increases the overall cost and complexity associated with manufacturing the vehicle and is often cumbersome and difficult to use. Furthermore, such hinge mechanisms and prop rods do not aid in absorbing energy during an impact event.

### SUMMARY

A hood-hinge assembly may include at least one structural member, a hinge linkage moveable between a closed position and an open position, and a hinge bracket disposed on the at least one structural member and supporting the hinge linkage. The hinge bracket being deformable in response to a force applied to the hinge linkage.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial side view of a hinge assembly according to the principles of the present invention and installed in a vehicle;

FIG. 2 is a right-side view of the hinge assembly of FIG. 1 in a closed position;

FIG. 3 is a right-side view of the hinge assembly of FIG. 1 in an open position;

FIG. 4 is a rear perspective view of the hinge assembly of FIG. 1;

FIG. 5 is a left perspective view of the hinge assembly of FIG. 1;

FIG. 6 is an exploded view of a hinge assembly according to the principles of the present invention;

FIG. 7 is a right side view of the hinge assembly of FIG. 1 in a deformed condition;

FIG. 8 is a partial perspective view of a hinge bracket disposed in an engine compartment of a vehicle;

FIG. 9 is perspective view of a hinge linkage according to the principles of the present invention and in a closed position;

FIG. 10 is a perspective view of the hinge linkage of FIG. 9 in an open position;

FIG. 11 is a side view of a hinge assembly according to the principles of the present invention and in a closed position;

FIG. 12 is a side view of the hinge assembly of FIG. 11 in an open position; and

FIG. 13 is a side view of the hinge assembly of FIG. 11 in a deformed condition.

### DETAILED DESCRIPTION

The following description is merely exemplary in nature and is not intended to limit the present disclosure, application, or uses. It should be understood that throughout the drawings, corresponding reference numerals indicate like or corresponding parts and features.

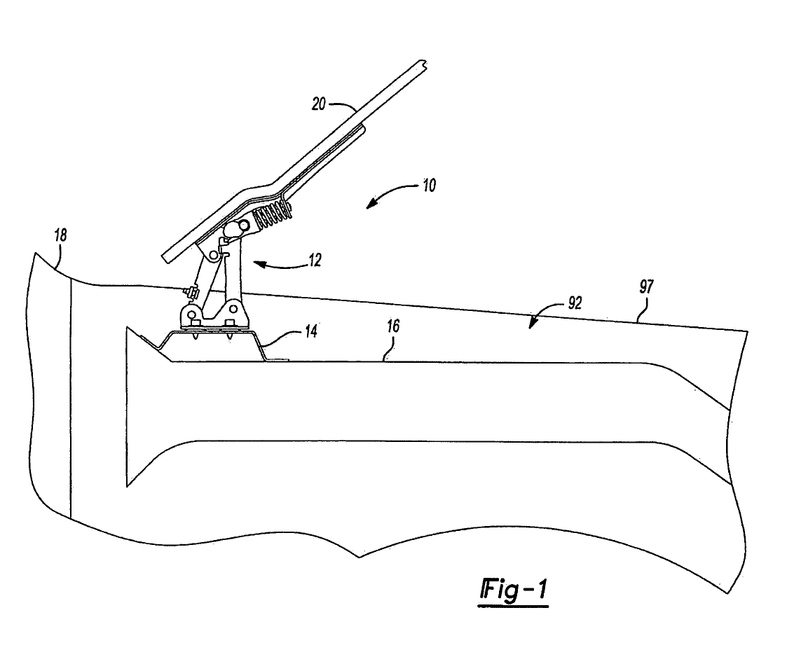

With reference to FIGS. 1-8, a hood-hinge assembly 10 is provided and includes a hinge linkage 12, a hinge bracket 14, and a rail 16. The hinge linkage 12 may be mounted to the hinge bracket 14, which in turn may be mounted to the rail 16 of a vehicle 18, for example. In one configuration, a hood 20 of the vehicle 18 may be fixedly mounted to the hinge linkage 12. The hinge linkage 12 may be selectively actuable to permit movement of the hood 20 between an open position and a closed position and may also retain the hood 20 in the open position (FIG. 1). The hinge bracket 14 may be deformable in response to an impact event to absorb energy associated with the impact event. The hinge assembly 10 is not limited in application to a hood, and may be adapted for use with any closure panel of the vehicle 18 such as, for example, a trunk, a tailgate, and/or a door.

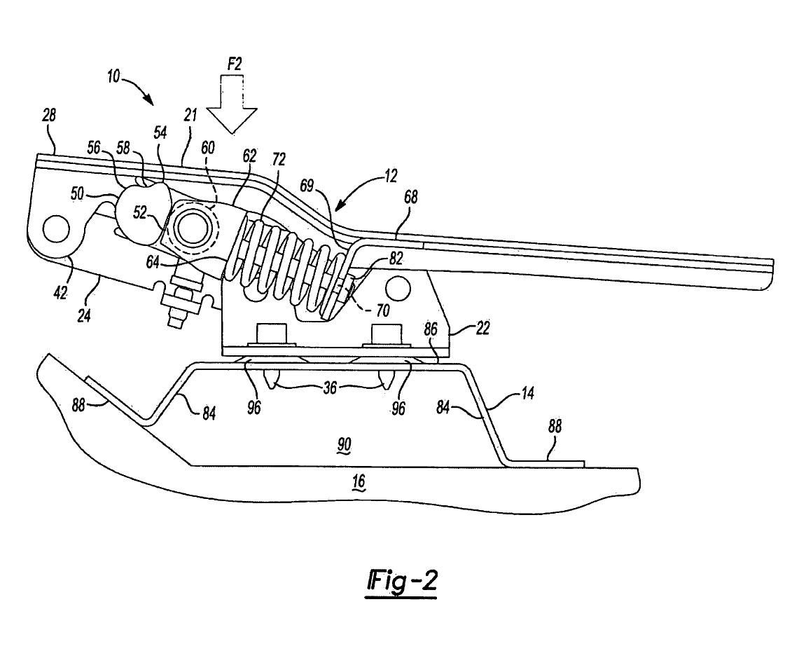

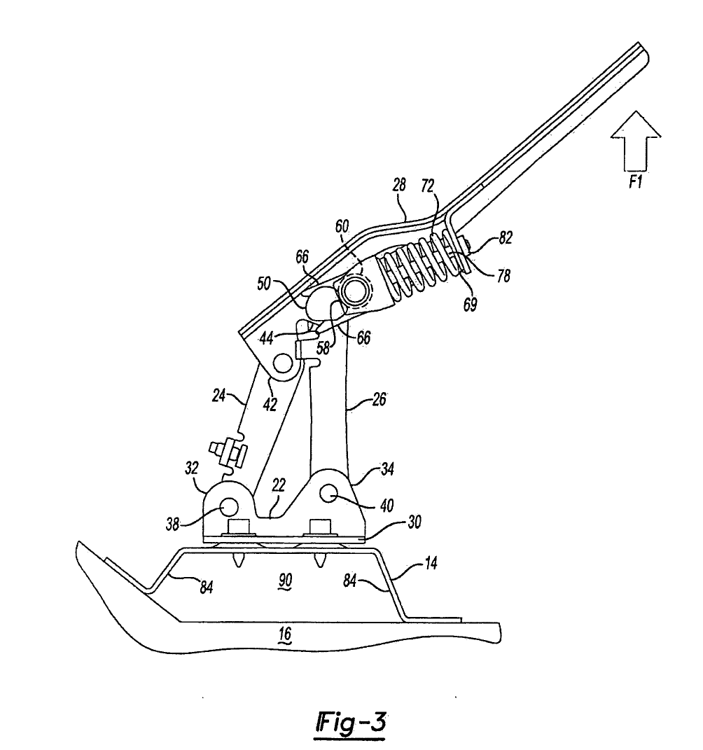

With reference to FIGS. 2 and 3, the hinge linkage 12 may be a four-bar linkage disposed between the hinge bracket 14 and the hood 20 and may include a fixed link 22, an aft link 24, a forward link 26, and an upper link 28. The fixed link 22 may include one or more mounting arms 30, an aft lobe 32 and a forward lobe 34. The mounting arm 30 may be fixedly mounted to the hinge bracket 14 via a plurality of bolts 36. While the mounting arm 30 is described as being a separate component, the mounting arm 30 may alternatively be integrally formed with the hinge bracket 14. Furthermore, while the mounting arm 30 is described as being attached to the hinge bracket 14 via bolts 36, the mounting arm 30 may alternatively be welded or otherwise suitably joined to the hinge bracket 14.

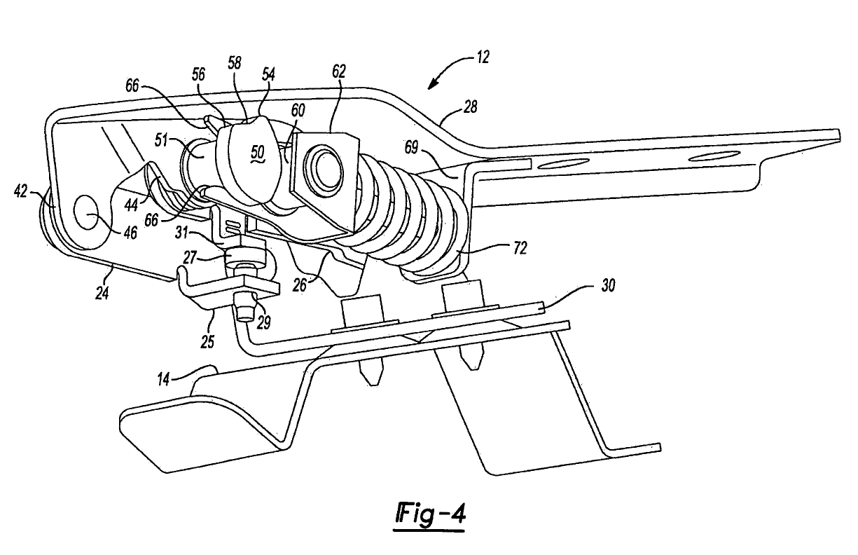

The aft link 24 may be an elongated member, and may include a generally L-shaped tab 25 (FIG. 4) having a stop pin 27 disposed in an aperture 29 thereof. The stop pin 27 may be welded into the aperture 29, or, alternatively, may be press fit, interference fit, threadably fastened, or otherwise suitably fixed to the tab 25. The forward link 26 may also be an elongated member, and may similarly include a generally L-shaped tab 31.

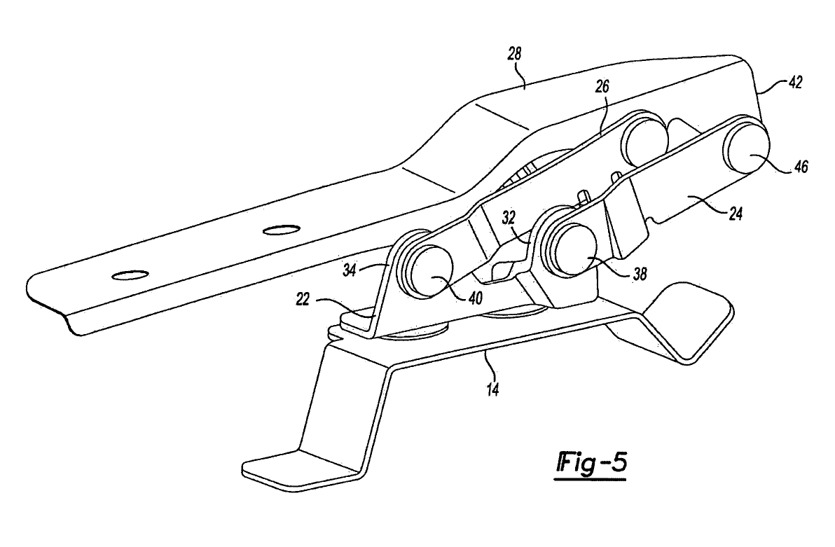

A pin 38 may be disposed through the aft link 24 and aft lobe 32 to provide pivotable engagement therebetween. Similarly, a pin 40 may be disposed through the forward link 26 and the forward lobe 34 to provide pivotable engagement therebetween. The aft lobe 32 may be offset relative to the forward lobe 34 to provide clearance between the forward link 26 and the aft lobe 32, as well as to provide clearance between the forward link 26 and the aft link 24 (FIG. 5).

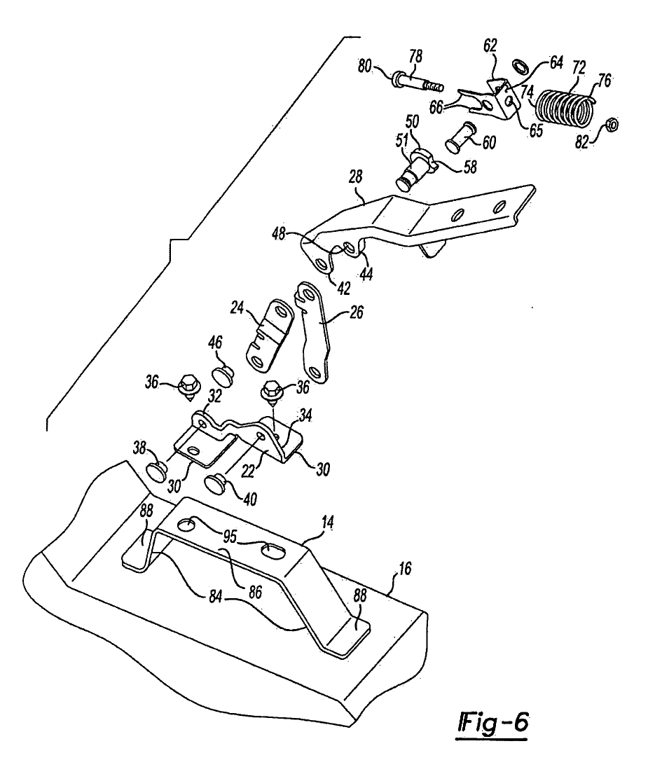

The upper link 28 may be an elongated member with a generally L-shaped cross-section and may include an aft lobe 42 and a forward lobe 44 (FIG. 6). The aft lobe 42 may be offset relative to the forward lobe 44 to provide clearance between the aft link 24 and the forward link 26 (FIG. 4). The aft link 24 may be pivotably engaged with the aft lobe 42 via a pin 46. The upper link 28 may be attached to the hood 20 and may move with the hood 20 relative to the hinge bracket 14 when the aft ink 24 and forward link 26 are moved relative to the hinge bracket 14.

A cam 50 may be disposed through the forward lobe 44 of the upper link 28 and may include a stem 51 fixedly mounted to the forward link 26 via an interference fit, press fit, threaded fasteners, and/or adhesive. The stem 51 may be pivotably engaged with an aperture 48 through the forward lobe 44, thereby providing a pivotable relationship between the forward link 26 and the upper link 28. The periphery of the cam 50 may include a flat 52, a first lobe 54, a second lobe 56, and a depression 58 formed generally between the lobes 54, 56 (FIG. 2).

A cam follower 60 may include a generally cylindrical shape and may be fixedly mounted to a retainer 62. The periphery of the cam follower 60 may be positioned against the periphery of the cam 50 (FIGS. 2 and 3). The retainer 62 may include a spring seat surface 64, which may be disposed substantially parallel to the longitudinal axis of the cam follower 60. The spring seat surface 64 may include a strut aperture 65. The retainer 62 may also include legs 66 protruding therefrom substantially perpendicular to the spring seat surface 64 such that the legs 66 straddle the stem 51 of the cam 50 (FIG. 4).

The upper link 28 may include a tab 68 that includes a spring seat 69. The spring seat 69 may be disposed substantially parallel to the spring seat surface 64 and may include a strut aperture 70. The spring-seat tab 68 may be integrally formed with the upper link 28, or, alternatively, be welded, fastened, or otherwise suitably fixed thereto.

A compression spring 72 may be disposed between the spring seat 69 and the spring seat surface 64. A first end 74 of the compression spring 72 may be fixedly mounted to the spring seat surface 64 and a second end 76 of the compression spring 72 may be fixedly mounted to the spring seat 69.

A strut 78 may be disposed through the center of the compression spring 72 along a longitudinal axis thereof. The strut 78 may be slidably engaged with the strut apertures 65, 70 of the spring seat surface 64 and the spring seat 69, respectively. The strut 78 may include stops 80, 82 to prevent the strut 78 from disengaging the spring seat surface 64 and the spring seat 69, respectively. The stop 80 may be integrally formed with the strut 78 and may include a nut threadably fixed to the strut 78 (FIG. 6). Either or both of the stops 80, 82 may alternatively be threadably fixed to the strut 78, or otherwise suitably fixed thereto.

The hinge bracket 14 may include at least one leg 84 and a cross member 86. Each of the legs 84 may include a foot 88. The legs 84 may connect the cross member 86 with the feet 88, thereby forming a deformation cavity 90 (FIG. 2) therebetween.

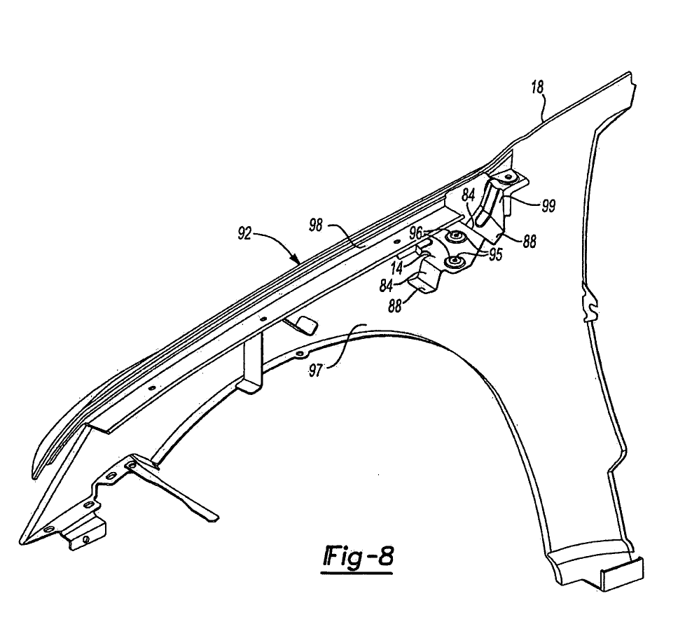

The hinge bracket 14 may include a plurality of mounting apertures 95 disposed through the cross member 86. The bolts 36 may be disposed through the mounting apertures 95 to fasten the fixed link 22 to the hinge bracket 14. The mounting apertures 95 may be generally circular or oblong and may be offset from each other relative to the longitudinal direction of the load beam 98 (FIG. 8). In this configuration, each of the mounting arms 30 may be disposed on opposing sides of the lobes 32, 34 of the fixed link 22 (FIG. 6).

The mounting arm 30 of the fixed link 22 may be fixedly mounted to the cross member 86 of the hinge bracket 14. The feet 88 may be welded or otherwise suitably fastened to the rail 16. The rail 16 may be any suitable structural member fixedly disposed within an engine compartment 92 of the vehicle 18 such as, for example, an engine support.

The cross member 86 may also include shim features 96 that are substantially centered around the mounting apertures 95. Through a process known as net-form and pierce manufacturing, the shim features 96 may be machined prior to and/or during installation of the hinge assembly 10 into the vehicle 18 to adjust the dimensional stack-up of the hinge assembly 10 and facilitate accurate alignment between the hood 20 and a fender 97.

A load beam 98 may be disposed along the fender 97 to provide additional support to the hood 20, while the hood 20 and, thus, the hinge linkage 12, is in the closed position. A portion of the load beam 98 may be fixed to a support feature 99, which may be integrally formed with the hinge bracket 14 (FIG. 8). In this configuration, the hinge bracket 14 and support feature 99 may cooperate to provide support for the load beam 98.

With reference to FIGS. 1-7, operation of the hinge assembly 10 will be described in detail. During normal operation of the vehicle 18, the hinge linkage 12 may be in a closed position (FIG. 2), enabling the hood 20 to securely enclose the engine compartment 92. In the closed position, the tab 31 of the forward link 26 may rest atop the stop pin 27, thereby limiting the range of counterclockwise motion of the aft link 24 and forward link 26 (relative to the view shown in FIG. 2) beyond the closed position.

A user may open the hood 20 by applying an upward force F1 to the upper link 28 via the hood 20, which, as described above, is fixedly mounted to the upper link 28. The upward force F1 applied to the hood 20 causes the aft link 24 and the forward link 26 to pivot about the aft lobe 32 and the forward lobe 34, respectively, in a clockwise direction relative to the view shown in FIGS. 2 and 3.

As the aft link 24 and the forward link 26 pivot in the clockwise direction, the periphery of the cam 50, which is fixed relative to the forward link 26, relative to the view shown in FIGS. 2 and 3 is rolled against the cam follower 60 in the clockwise direction. As the cam follower 60 is rollingly engaged with the first lobe 54 of the cam 50, the cam follower 60 causes the retainer 62 to compress the compression spring 72 between the spring seat surface 64 and the spring seat 69.

Continued pivoting of the aft link 24 and the forward link 26 in the clockwise direction relative to the view shown in FIGS. 2 and 3 into an open position (FIG. 3) allows the compression spring 72 to urge the cam follower 60 into the depression 58 of the cam 50 such that the cam follower 60 is releasably received in the depression 58 between the first lobe 54 and the second lobe 56.

The force of gravity acting on the hood 20 and, hence the upper link 28, may be insufficient to cause the compression spring 72 to sufficiently compress so as to allow the first lobe 54 of the cam 50 to roll back over the cam follower 60 in a counterclockwise direction (relative to the view shown in FIG. 3) towards the closed position. Therefore, the hinge linkage 12, and hood 20 may be retained in the open position, until the user applies a sufficient downward force (i.e., a force in a direction substantially opposite to F1) to the hood 20 to cause the compression spring 72 to compress a sufficient distance and provide clearance for the first lobe 54 to roll over the cam follower 60. Once the spring 72 is sufficiently compressed such that the first lobe 54 is permitted to roll over the cam follower 60, the aft link 24 and the forward link 26 pivot counterclockwise (relative to the view shown in FIG. 3) towards the closed position.

In the closed position, the compression spring 72 may exert a biasing force on the flat portion 52 of the cam 50, thereby biasing the forward link 26 in a counterclockwise direction relative to the view shown in FIG. 3 such that the tab 31 is firmly biased against the stop pin 27. This biasing force may decrease vibration between the hinge linkage 12 and the hood 20 and/or decrease the tendency of the hood 20 to open or bounce due to turbulent air flow over the hood 20 during normal driving conditions.

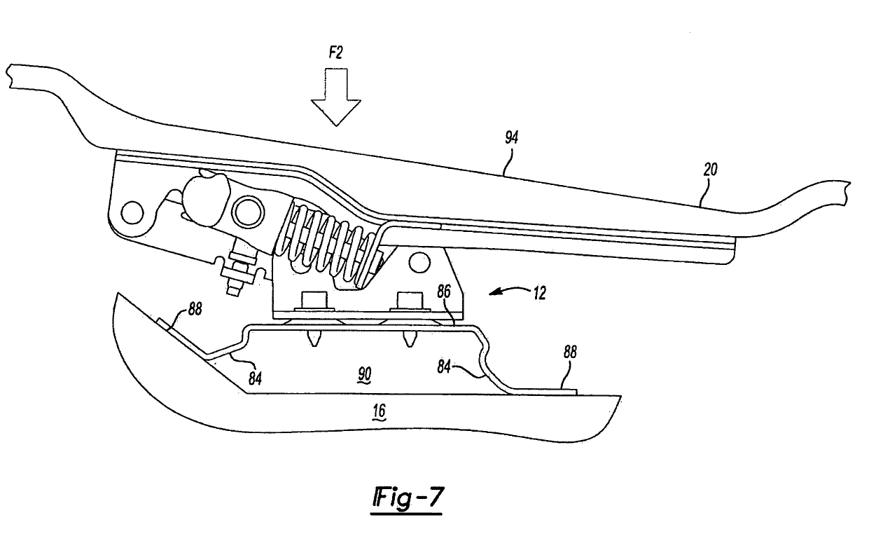

During operation of the vehicle 18, the hood 20 may experience an impact event at or near a portion 94 of the hood 20 disposed directly above the hinge linkage 12 whereby a force F2 (FIG. 7) is exerted substantially normal to an external surface 21 of the hood 20. In response to the impact event, the hinge bracket 14 may plastically deform in a downward direction (relative to the view shown in FIG. 7). The impact event may cause the legs 84 to buckle or deform, thereby collapsing the deformation cavity 90 to allow the hinge linkage 12 and the cross member 86 to displace toward the rail 16. Such displacement allows a portion 94 of the hood 20 positioned above the hinge linkage 12 to deflect (FIG. 7), thereby absorbing energy of the impact event. The fender 97 may also be deformable to absorb energy of an impact event such that the fender 97 works in conjunction with the hinge linkage 12 in absorbing energy.

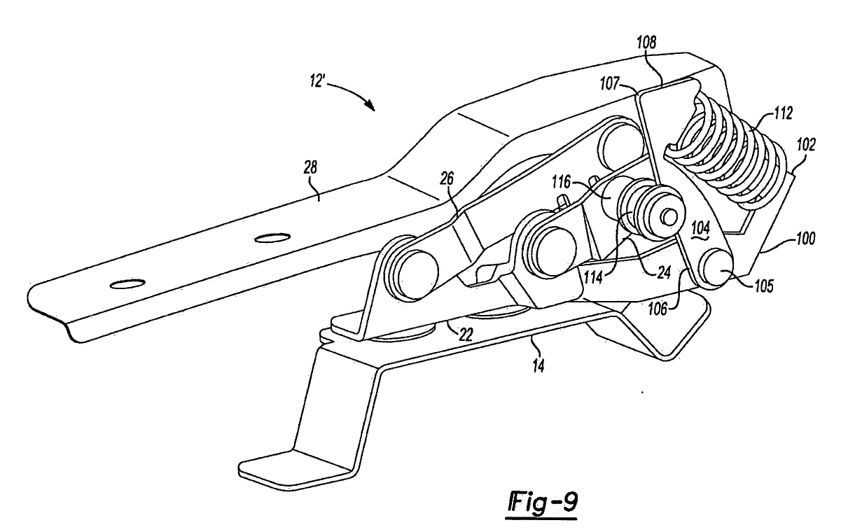

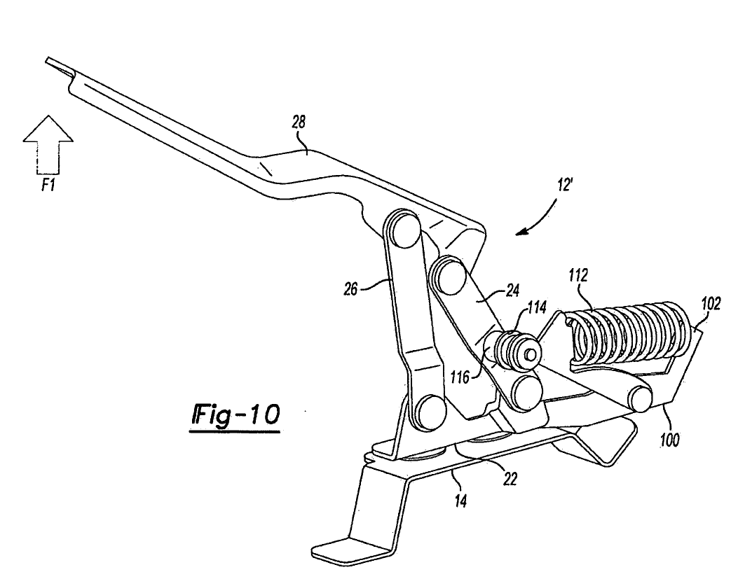

With reference to FIGS. 9 and 10, a hinge linkage 12′ is provided and may include the fixed link 22, the aft link 24, the forward link 26, and the upper link 28, as described above with reference to the hinge linkage 12. The fixed link 22 may include a generally L-shaped arm 100 rigidly protruding therefrom having a spring seat 102.

A cam lever 104 may be pivotably mounted to the arm 100 about a pin 105 and may include a generally L-shape having a first surface 106, an elbow 107, a second surface 108, and a spring seat 110. A compression spring 112 may be disposed between the arm 100 and the cam lever 104 and may be fixedly mounted to the spring seats 102, 110.

A peg 114 may be mounted to the aft link 24 for engagement with the cam lever 104 and may include a shaft portion 116 that is either fixedly or rotatably mounted to the aft link 24. The compression spring 112 may biasingly urge the cam lever 104 into sliding engagement with the shaft portion 116.

A user may open the hood 20 by applying the upward force F1 to the hood 20 (and hence the upper link 28). As the forward link 26 and the aft link 24 pivot about the fixed link 22 in a counter clockwise direction (relative to the view shown in FIGS. 9 and 10), the peg 114 may slide against the first surface 106 of the cam lever 104 towards the elbow 107, thereby forcing the cam lever 104 to pivot about the pin 105 in a clockwise direction (relative to the view shown in FIGS. 9 and 10). Such rotational movement of the cam lever 104 causes compression of the compression spring 112 against the spring seat 102. The biasing force of the compression spring 112 may be greatest when the peg 114 is disposed against the elbow 107 and may linearly decrease with the distance between the peg 114 and the elbow 107. Therefore, the biasing force of the compression spring 112 may decrease as the peg 114 slides from the elbow 107 onto the second surface 108.

In an open position (FIG. 10), the peg 114 may be disposed on the second surface 108 of the cam lever 104. The hinge linkage 12′ may be retained in the open position by a balance between the gravitational force of the hood 20 and the biasing force of the compression spring 112 urging the cam lever 104 against the peg 114. The weight of the hood 20 and the hinge linkage 12′ may not be sufficient to compress the compression spring 112 enough to allow the peg 114 to slide back over the elbow 107 and onto the first surface 106. Therefore, the hinge linkage 12′ may retain the hood in the open position without assistance from a prop rod.

To close the hood 20, a user may supplement the downward gravitational force of the hood 20 and the hinge linkage 12′ by applying a downward force to the hood 20 such that the resultant force is sufficient to overcome the biasing force of the compression spring 112 when the peg 114 is disposed against the elbow 107.

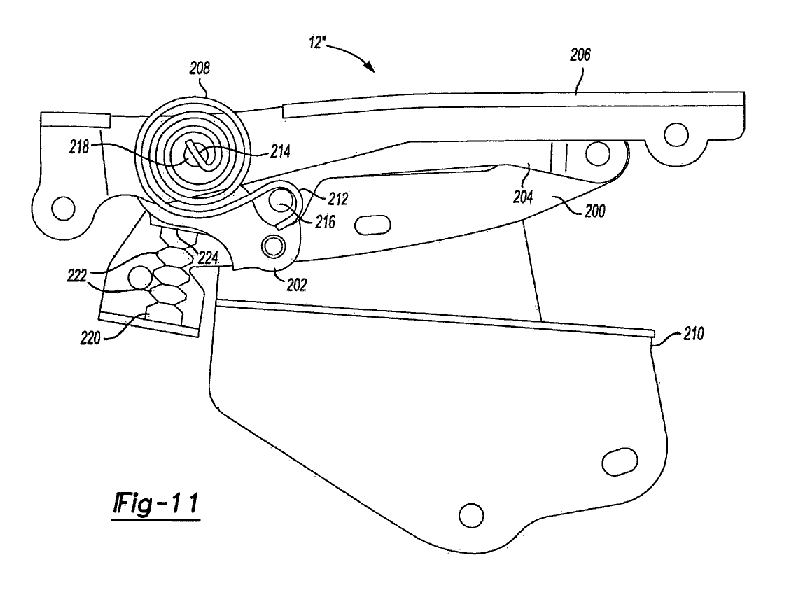

With reference to FIGS. 11-13, a hinge linkage 12″ is provided and may include a fixed link 200, an aft link 202, a forward link 204, an upper link 206, and a coil spring 208. The fixed link 200 may be integrally formed with a bracket 210, which may be fixedly mounted to a structural member within the engine compartment 92 of the vehicle 18, such as, for example, the rail 16.

The aft link 202 and the forward link 204 may be pivotably mounted to the fixed link 200 and the upper link 206 may be pivotably mounted to the aft link 202 and the forward link 204.

The coil spring 208 may include an outer hook 212 and an inner leg 214. The outer hook 212 may be engaged with a tab 216 disposed on the forward link 204 and the inner leg 214 may be fixed to a pin 218, which, in turn, may be fixed to the upper link 206. The coil spring 208 may bias the forward link 204 (and hence the aft link 202) to pivot about the fixed link 200 in a clockwise direction (relative to the views shown in FIG. 11).

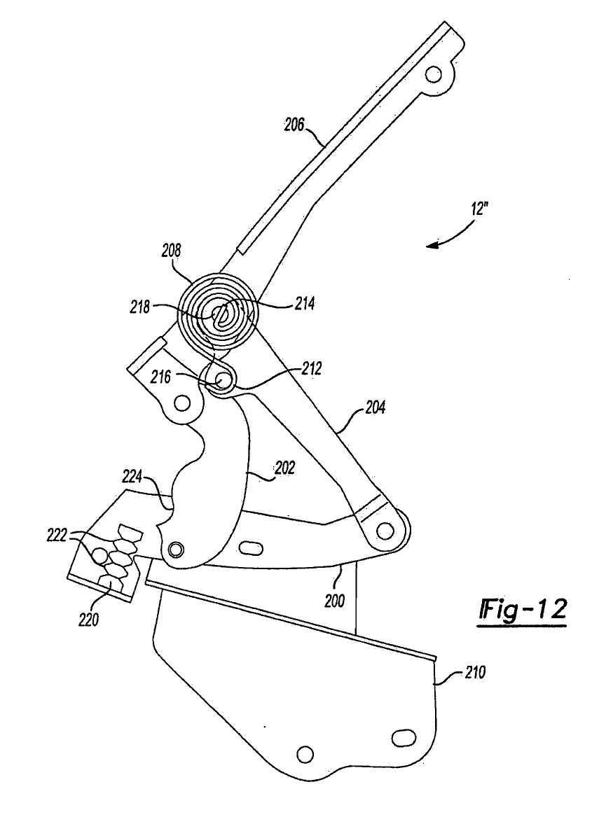

In an open position (FIG. 12), the biasing force of the coil spring 208 urging the links 202, 204, 206 into the open position in combination with the a combined frictional force between the links 200, 202, 204, 206 may balance or slightly exceed the gravitational force of the hood 20 and the hinge linkage 12″. Therefore, the coil spring 208 may retain the hinge linkage 12″ in the open position until a user supplements the gravitational force of the hood 20 and hinge linkage 12″ by applying a downward force to the hood 20.

A linkage stop 220 may be welded or otherwise fixedly attached to the fixed link 200. The linkage stop 220 may be steel (or any other suitable metal) and may include a plurality of baffles 222 to facilitate plastic deformation of the linkage stop 220 in response to an impact event.

When the hinge linkage 12″ is configured in a closed position (FIG. 11), a stop surface 224 disposed on the aft link 202 rests atop the linkage stop 220, thereby limiting the counterclockwise pivoting motion of the links 202, 204, 206 (relative to the view shown in FIG. 11).

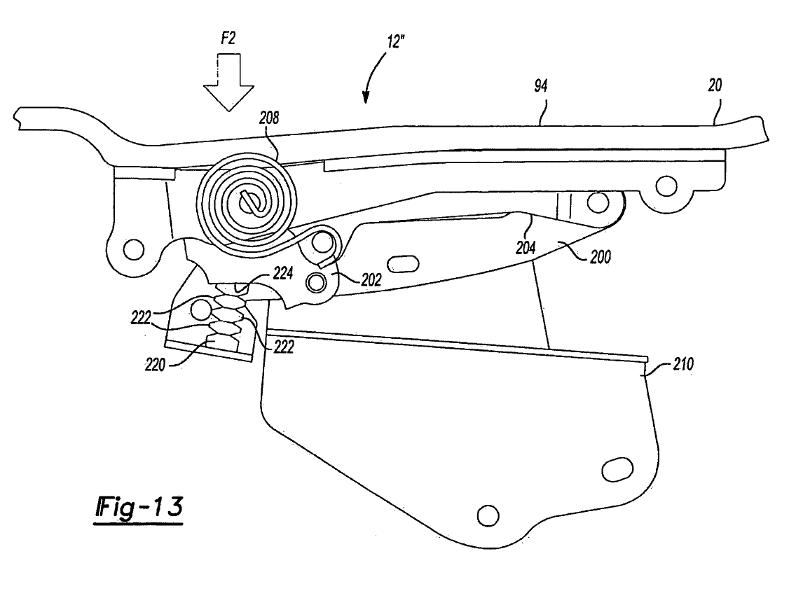

The hood 20 may experience an impact event at or near a portion 94 of the hood 20 disposed directly above the hinge linkage 12″. The impact event may cause the aft link 202 and the forward link 204 to pivot about the fixed link 200 in a counterclockwise direction (relative to the view shown in FIG. 13), thereby plastically deforming the linkage stop 220. The plastic deformation of the linkage stop 220 may absorb the energy of the impact event.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A hood-hinge assembly for a hood, the hood-hinge assembly comprising:
a hinge linkage permitting movement of the hood between an open position and a closed position; and
a hinge bracket disposed on a structural member of a vehicle and supporting said hinge linkage, said hinge bracket being deformable to allow deflection of a portion of the hood above said hinge bracket in response to an impact event.

2. The hood-hinge assembly according to claim 1, wherein said impact event applies a force to a surface of the hood that is substantially normal to said surface.

3. The hood-hinge assembly according to claim 1, wherein said hinge linkage is adapted to retain the hood in an open position.

4. The hood-hinge assembly according to claim 1, wherein said hinge bracket includes a deformation cavity.

5. The hood-hinge assembly according to claim 1, wherein said hinge bracket includes a deformable linkage stop.

6. A hood-hinge assembly comprising:
at least one structural member;
a hinge linkage moveable between a closed position and an open position; and
a hinge bracket disposed on said at least one structural member and supporting said hinge linkage, said hinge bracket being deformable in response to a force applied to said hinge linkage.

7. The hood-hinge assembly according to claim 6, further comprising:
a cam, a cam follower, and a biasing member that cooperate to maintain said hinge linkage is said open position.

8. The hood-hinge assembly according to claim 7, wherein said cam include plurality of lobes that receive said cam follower therebetween to retain said hinge linkage in said open position.

9. The hood-hinge assembly according to claim 8, wherein said biasing member urges said cam follower into engagement with said cam.

10. The hood-hinge assembly according to claim 6, further comprising a peg, a lever, and a biasing member, said biasing member urging said lever against said peg to bias said hinge linkage into said open position.

11. The hood-hinge assembly according to claim 6, wherein said hinge bracket includes a cross member and at least one leg connecting said cross member and said at least one structural member to form a deformation cavity therebetween.

12. The hood-hinge assembly according to claim 11, wherein said deformation cavity allows said hinge bracket to deformably displace in response to said force.

13. The hood-hinge assembly according to claim 11, wherein said at least one leg is deformable within said deformation cavity in response to said force.

14. The hood-hinge assembly according to claim 6, wherein said hinge linkage is a four-bar linkage.

15. A vehicle comprising:
at least one structural member;
a hinge linkage moveable between a closed position and an open position; and
a hinge bracket disposed on said at least one structural member and supporting said hinge linkage, said hinge bracket being deformable in response to a force applied to said hinge linkage.

16. The vehicle according to claim 15, further comprising:
a cam, a cam follower, and a biasing member that cooperate to maintain said hinge linkage is said open position.

17. The vehicle according to claim 16, wherein said cam include plurality of lobes that receive said cam follower therebetween to retain said hinge linkage in said open position.

18. The vehicle according to claim 17, wherein said biasing member urges said cam follower into engagement with said cam.

19. The vehicle according to claim 15, further comprising a peg, a lever, and a biasing member, said biasing member urging said lever against said peg to bias said hinge linkage into said open position.

20. The vehicle according to claim 15, wherein said hinge bracket includes a cross member and at least one leg connecting said cross member and said at least one structural member to form a deformation cavity therebetween.

21. The vehicle according to claim 20, wherein said deformation cavity allows said hinge bracket to deformably displace in response to said force.

22. The vehicle according to claim 20, wherein said at least one leg is deformable within said deformation cavity in response to said force.

23. The vehicle according to claim 15, wherein said hinge linkage is a four-bar linkage.
